(19) United States
(12) Patent Application Publication
(10) Pub. No.: US 2013/0169660 A1
(43) Pub. Date: Jul. 4, 2013

(54) IMAGE EDITING SYSTEM AND METHOD

(71) Applicants: CHENG-ZHI LI, Shenzhen (CN); QIANG YOU, Shenzhen City (CN)

(72) Inventors: CHENG-ZHI LI, Shenzhen (CN); QIANG YOU, Shenzhen City (CN)

(73) Assignees: HON HAI PRECISION INDUSTRY CO., LTD., New Taipei (TW); FU TAI HUA INDUSTRY (SHENZHEN) CO., LTD., ShenZhen City (CN)

(21) Appl. No.: 13/431,994

(22) Filed: Mar. 28, 2012

(30) Foreign Application Priority Data
Dec. 29, 2011 (CN) 201110452265.1

(51) Int. Cl. G09G 5/02; G09G 5/00

(52) U.S. Cl. 345/589; 345/625

(57) ABSTRACT

An image editing system includes a screen for displaying a plurality of continuous frames of images. A menu generating unit, connected with the screen, generates a visual menu on the screen when running the image editing system for prompting a user to implement a start operation. A display control unit responds to the start operation to stop receiving the next frame of the image and keeps the screen displaying the current frame of the image. As well as an image obtaining unit, responds to editing operations of the user on the current frame of the image to cut a section of the image from the current frame of the image. An image editing method is also provided.

### BACKGROUND

1. Technical Field

The present disclosure relates to image editing systems and methods, and more particularly, to an image editing system and a method capable of obtaining a section of an image displayed on a screen easily.

2. Description of Related Art

When viewing images or videos on an electronic device, the user may want to save a section of the image, which is being displayed. However, many electronic devices can only save the entire image that is being displayed, e.g., Print Screen. In order to save a section of the image, the user needs to save the entire image on the screen first, then open and edit the saved image, which can be time consuming and difficult.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of one embodiment of an image editing system in accordance with the present disclosure.

FIG. 2 is a first state diagram of one embodiment of the image editing system in FIG. 1.

FIG. 3 is a second state diagram of one embodiment of the image editing system in FIG. 1.

FIG. 4 is a flowchart of a method for editing an image by the image editing system in FIG. 1, in accordance with an embodiment.

### DETAILED DESCRIPTION

Embodiments of the present disclosure will be described below, with reference to the accompanying drawings.

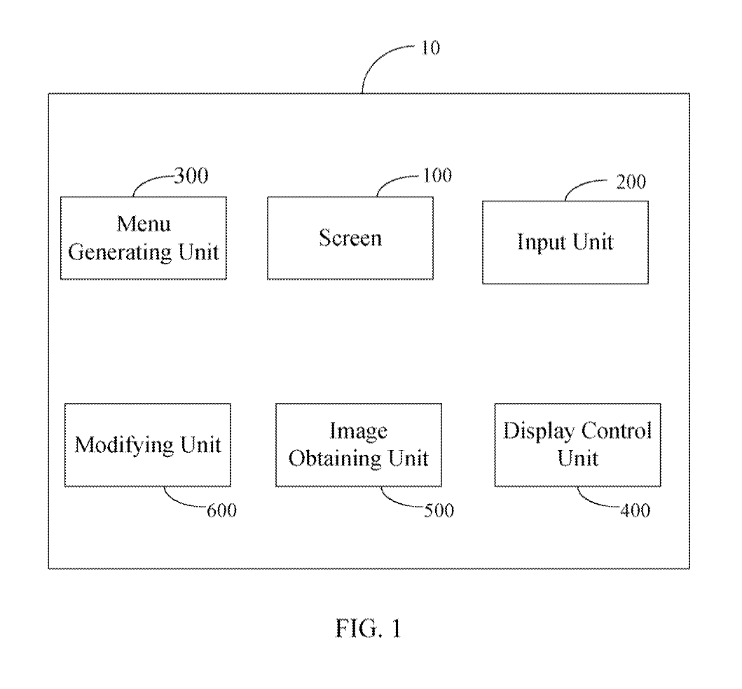

FIG. 1 is a block diagram of one embodiment of an image editing system 10 in accordance with the present disclosure. The image editing system 10 can be run on an electronic device. The electronic device can be a mobile phone or tablet computer. The image editing system 10 includes a screen 100, an input unit 200, a menu generating unit 300, a display control unit 400, an image obtaining unit 500, and a modifying unit 600.

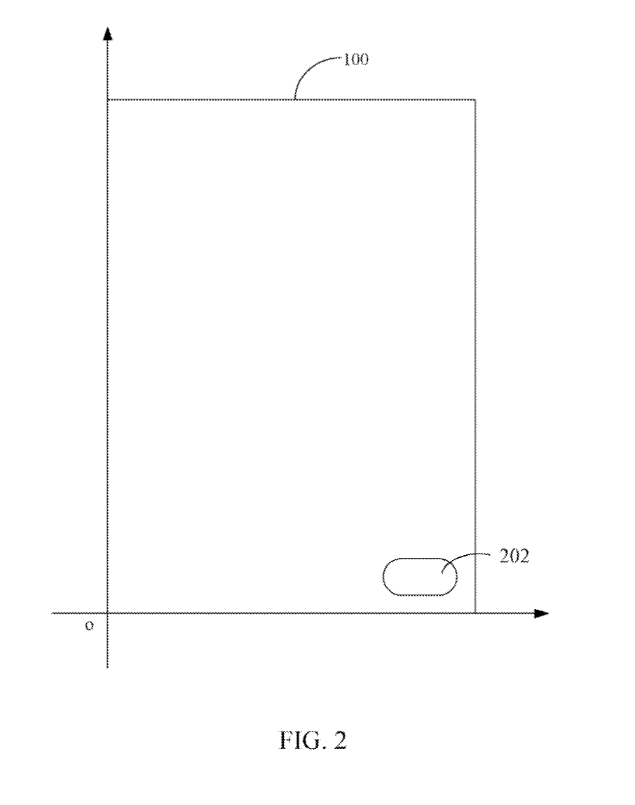

FIG. 2 is the screen 100 being used to display a plurality of continuous frames of images. The images may be obtained from an internal memory of the electronic device, e.g., hard disk or SD card, or other electronic devices connected with the electronic device The screen 100 can display the plurality of continuous frames of images in a preset rate when displaying video files or web page. Each frame of the image is consisted with a matrix of pixels. Each pixel may be 32-bit binary to represent coordinate values of the pixels.

The input unit 200 is used to receive the input of a user. The input unit 200 may be a touch panel, for sensing touch input of the user, or a mouse.

The menu generating unit 300 is connected with the screen 100, for generating a visual menu on the screen 100 when running the image editing system 10 for prompting to the user to implement a start operation. The visual menu includes a first visual button 202 for prompting to the user to implement the start operation.

The display control unit 400 is used to respond to the start operation, to stop receiving next frame of image, and keep the screen 100 displaying the current frame of image 12.

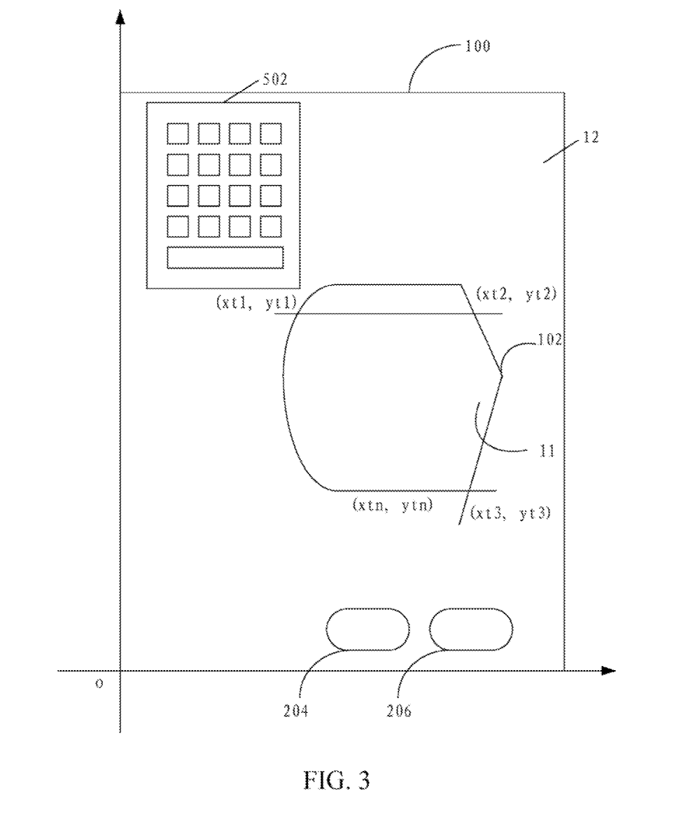

In FIG. 3, the image obtaining unit 500 responds to editing operations from the user on the current frame of the image 12 to cut a section of the image 11 from the current frame of the image 12. The section of the image 11 includes a desired area that the user wants to save. The editing operations may be an operation of touching or an operation of operating the mouse to move the cursor on the current frame of the image 12. The image obtaining unit 500 obtains the data in the desired area, and stores the data of the section of the image 11. Other data not in the section of the image 11 on the current frame of image 12 can be modified.

The editing operations generate a track 102 which encloses the desired area. The input unit 200 detects the touch operation or the sliding of the cursor to get coordinate values (xtn, ytn) of all points on the track 102. The track 102 is a closed curve. The image obtaining unit 500 compares all coordinate values of the points on the track. If two points have same coordinate values, e.g., (xt3, yt3), the track 102 is determined to be a closed curve.

When the track 102 is a closed curve, the menu generating unit 300 further generates a second visual button 204 and a third visual button 206 to operate a confirm operation and a cancel operation of the section of the image 11 respectively. A click or touch operation of the second visual button 204 of the user confirms the editing operations of the section of the image 11, and the click or touch operation of the third visual button 206 of the user cancels the editing operations of the section of the image 11.

The modifying unit 600 is connected with the image obtaining unit 500, modifying other data that is not in the section of the image 11 of the current frame of the image 12, e.g., modifying values of RGB. The modifying unit 600 generates a color mixing board 502 on the screen 100 to receive modifying operations.

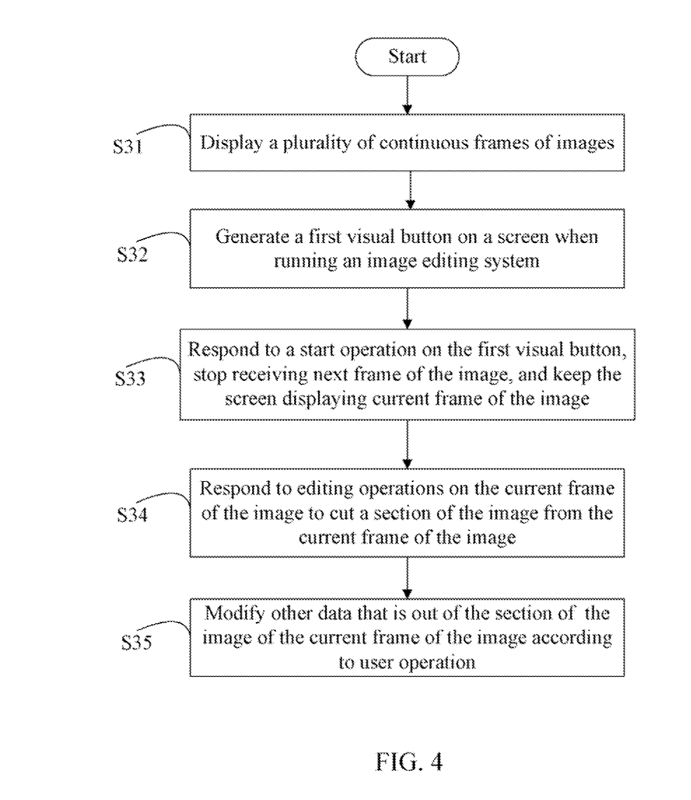

FIG. 4 is a flowchart of a method for editing an image by the image editing system in FIG. 1, in accordance with an embodiment.

In step S31, the screen 100 displays a plurality of continuous frames of images.

In step S32, the menu generating unit 300 generates the first visual button 202 on the screen 100 when running the image editing system.

In step S33, the display control unit 400 responds to the start operation on the first visual button 202 to stop receiving next frame of the image and keep the screen 100 displaying the current frame of the image 12.

In step S34, the image obtaining unit 500 responds to the editing operations on the current frame of the image 12 to cut the section of the image 11 from the current frame of the image 12.

In step S35, the modifying unit 600 modifies other data out of the section of the image 11 of the current frame of the image 12 according to the user operation.

Using the method above, the user can keep the screen displaying the current frame of the image 12, edit the current frame of the image 12 on the screen to cut the section of the image 11 from the current frame of the image 12. In addition, other data out of the section of the image 11 of the current frame of the image 12 can be modified, which saves time and operates easily.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An image editing system comprising:
a screen to display a plurality of continuous frames of images;
a menu generating unit, connected with the screen, to generate a visual menu on the screen when running the image editing system for prompting a user to implement a start operation;
a display control unit, to respond to the start operation to stop receiving next frame of the image and keep the screen to display a current frame of the image; and
an image obtaining unit, to respond to editing operations of the user on the current frame of the image to cut a section of image from the current frame of image.

2. The image editing system of claim 1, further comprising a modifying unit connected with the image obtaining unit to modify other data that is not in the section of the image of the current frame of the image.

3. The image editing system of claim 2, wherein the modifying unit generates a color mixing board on the screen to receive modifying operations.

4. The image editing system of claim 2, wherein the modifying unit modifies values of RGB.

5. The image editing system of claim 1, further comprising an input unit to receive inputs of the user.

6. The image editing system of claim 1, wherein the editing operations generate a track which encloses a desired area that the user wants, and the track is a closed curve.

7. The image editing system of claim 6, wherein when the track is detected to be a closed curve, the menu generating unit further generates a second visual button and a third visual button to operate a confirm operation and a cancel operation of the section of image, an operation of the second visual button of the user means for confirming the editing operations of the section of image, and an operation of the third visual button of the user means for canceling the editing operations of the section of image.

8. An image editing method implemented by an image editing system, the image editing method comprising:
displaying a plurality of continuous frames of images on a screen;
generating a visual menu on the screen when running the image editing system for prompting a user to implement a start operation;
responding to the start operation to stop receiving next frame of the image and keep the screen to display a current frame of the image; and
responding to editing operations of the user on the current frame of the image to cut a section of image from the current frame of the image.

9. The image editing method of claim 8, wherein the method further comprises step of modifying other data that is not in the section of the image of the current frame of the image.

10. The image editing method of claim 8, wherein the method further comprises step of generating a color mixing board on the screen to receive modifying operations.

11. The image editing method of claim 10, wherein the modifying operations are used to modify values of RGB.

12. The image editing method of claim 8, wherein the method further comprises step of receiving inputs of the user.

13. The image editing method of claim 8, wherein the editing operations generate a track which encloses a desired area that the user wants, and the track is a closed curve.

14. The image editing method of claim 8, wherein the method further comprises steps: when the track is detected to be a closed curve, generating a second visual button and a third visual button to operate a confirm operation and a cancel operation of the section of image, an operation of the second visual button of the user means for confirming the editing operations of the section of image, an operation of the third visual button of the user means for canceling the editing operations of the section of image.
